(19) United States
(12) Patent Application Publication
(10) Pub. No.: US 2007/0257489 A1
(43) Pub. Date: Nov. 8, 2007

(54) Coupled magnetic rotary discs for power generating

(76) Inventor: Wade Lee Wang, Taipei (TW)

Correspondence Address: BACON & THOMAS, PLLC, 625 SLATERS LANE, FOURTH FLOOR, ALEXANDRIA, VA, 22314, US

(21) Appl. No.: 11/429,161

(22) Filed: May 8, 2006

(51) Int. Cl. H02K 7/18; F03G 7/08; F02B 63/04

(52) U.S. Cl. 290/1 R

(57) ABSTRACT

Coupled magnetic rotary discs for power generating comprises a plurality of vertical and horizontal rotary discs each having two strong permanent magnets, the rotary discs are interconnected by gears, chain wheels or constant velocity universal joints, etc., so that they rotate synchronously. Each of the vertical rotary discs is located close to a corresponding horizontal rotary disc, and a position at which the magnets meet after each 360-degree rotation of the respective rotary discs is fixed. The polarity direction of the permanent magnets on the respective rotary discs are properly arranged to prevent the generation of magnetic rotary drag force, the magnets on the horizontal rotary discs are subjected to a push force and an attraction force of the permanent magnets on the vertical discs; the respective vertical rotary discs are arranged at different rotary angular positions so that the horizontal discs will be subjected to a magnetic force at certain angle interval of rotation.

### FIELD OF THE INVENTION

The present invention relates to a power generating equipment, and more particularly to coupled magnetic rotary discs for power generating, wherein a plurality of vertical and horizontal rotary discs are each placed with two strong permanent magnets whose polarities are arranged in different directions, these rotary discs are interconnected by gears, chain wheels or constant velocity universal joints, etc., so that they can rotate synchronously. Magnetic forces at different angles rotate a power generating equipment permanently.

### BACKGROUND OF THE INVENTION

Petroleum and nuclear power are two great energy sources for human beings, but they are not permanent energy sources. Hence, various new energy sources must be developed, including wind power, waterpower, tidal power, steam pressure power, and these powers are used to rotate a generator. Magnetic force is the power source that never be used by human beings.

With the fast development of the permanent magnetic technology, today, an NdFeB permanent magnet of 60 mm diameter can pick up a steel plate of 1000 kgs. Since the magnetic force lines of a magnet are closed, it should find a way to ward off the magnetic drag force, and then to take out the magnetic force and use it. However, such a way was never found.

### SUMMARY OF THE INVENTION

The primary objective of the present invention is to provide coupled magnetic rotary discs for power generating, the rotation is revised from plane type rotation to spatial type rotation, closed magnetic force loop is formed in a plane, and a linkage mechanism is used to make the magnets meet at the same position after each revolution. In this way, the problem of magnetic drag force—the headache of numberless inventors—is successfully solved, and the magnetic force can be used as a permanent rotary power source, thus creating a power generating equipment with perpetual motion.

Coupled magnetic rotary discs for power generating in accordance with the present invention comprises: at least four rotary discs, half are vertical rotary discs and half are horizontal rotary discs, the rotary discs is made of non-magnetoconductive material; two permanent magnets are fixed on each rotary disc, wherein each vertical rotary disc is corresponding to a nearby horizontal rotary disc; the horizontal discs rotate coaxially, and the vertical discs rotate about different axes; the rotary discs are interconnected by chain wheels, gears or constant velocity universal joints and thus rotate synchronously, so that the position at which the magnets meet after each 360-degree rotation of the respective rotary discs will be fixed; and the motion-transmitting direction of the chain is not parallel to the ground, the polarity direction of the permanent magnets on the respective rotary discs are properly arranged to prevent the generation of magnetic rotary drag force; the magnets on the horizontal rotary discs are subjected to a push force and an attraction force of the permanent magnets on the vertical discs; the horizontal rotary discs and the vertical rotary discs must rotate synchronously by linkage mechanism; the respective vertical rotary discs are arranged at different rotary angular positions so that the horizontal discs will be subjected to a magnetic force at certain angle interval of rotation.

The present invention will be better understood from the following description when viewed together with the accompanying drawings, which show, for purpose of illustrations only, the preferred embodiment in accordance with the present invention.

### BRIEF DESCRIPTION OF THE DRAWINGS

FIG. 1 is an illustrative view for showing the operation theory of the present invention;

FIG. 2 shows that every 360-degree rotation of four mid discs produces 8 times of magnetic-force acceleration;

FIG. 3 is a force analysis diagram of the rotary discs; and

FIG. 4 shows the transmission mechanism in accordance with the present invention.

### DETAILED DESCRIPTION OF THE PREFERRED EMBODIMENT

The foregoing, and additional objects, features and advantages of the present invention will become apparent from the following detailed description of preferred embodiment thereof, taken in conjunction with the accompanying drawings.

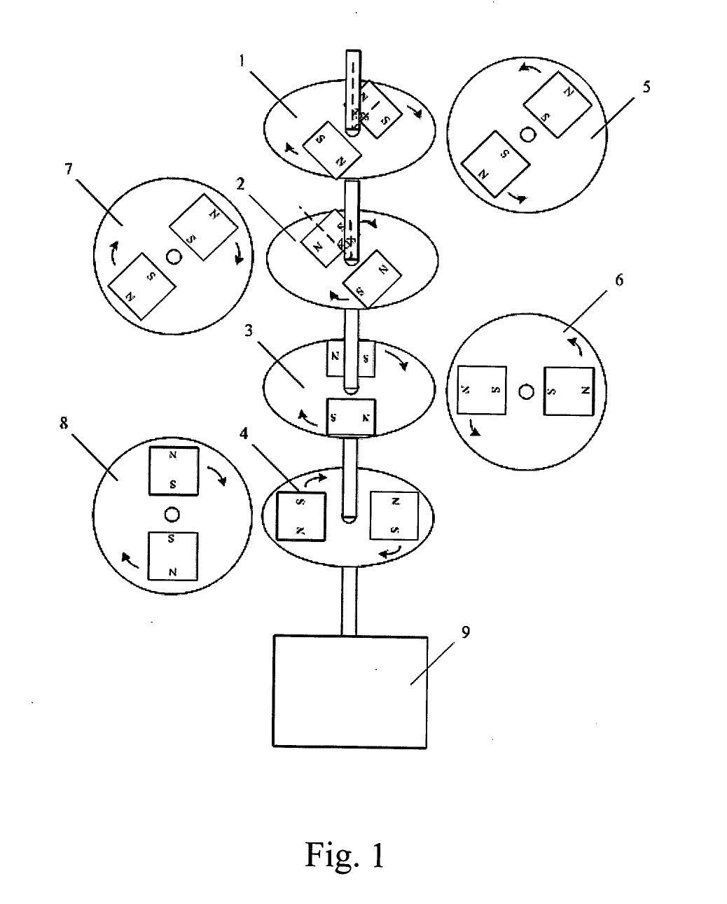

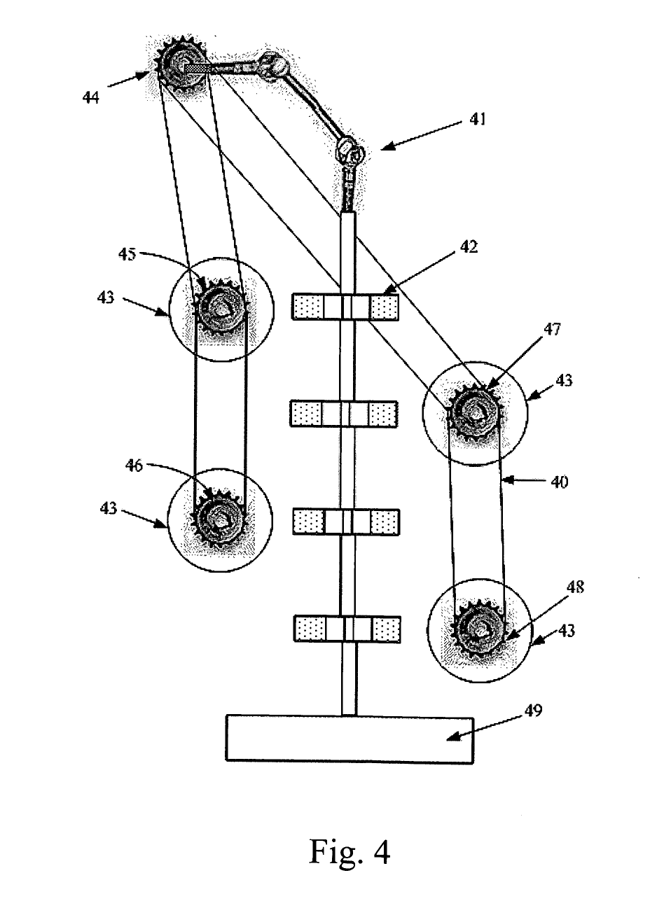

Referring first to FIG. 1, coupled magnetic rotary discs for power generating in accordance with the present invention comprises: two left discs 7 and 8, four mid discs 1, 2, 3 and 4, and two right discs 5 and 6, which are interconnected together by gears, chain wheels or constant velocity universal joints (shown in FIG. 4), etc. The left discs are coupled to the mid discs, and the mid discs are coupled to the right discs, so that each disc rotates at synchronous speed. To prevent the push and attraction forces from interfering with each other, each disc can only be provided with two magnets, not four magnets. To maintain the rotation, it would be better to arrange at least four mid discs in the middle, but the number of the mid discs can be increased up to 18 or more.

The left discs 7, 8 and the right discs 5, 6 rotate vertically, and the mid discs 1, 2, 3 and 4 rotate horizontally, thus preventing the magnetic drag force, and the magnetic push and attraction forces are utilized to produce rotary force. The left discs 7, 8 and the right discs 5, 6 rotate about four different axes, respectively. The mid discs 1, 2, 3 and 4 rotate coaxially around the rotary shaft of the generator 9, as shown in the drawings.

The magnetic polar direction of the respective discs is designed such that when the magnets of the left discs 7, 8 and the right discs 5, 6 meet the magnets of the mid discs 1, 2, 3 and 4, different poles attract and same poles repel, produce a rotary force for rotating the mid discs. The magnetic action of the left and the right discs with respect to the mid discs accelerates the rotation of the mid discs. Since the respective discs rotate synchronously, the left and right discs will accelerate along with the acceleration of the mid discs.

The delay angle of rotation of the magnets of the left discs (the right discs) with respect to the magnets of the mid discs is 90 degrees, so that when the magnets of the left discs move down, the magnets of the mid discs have already left the connecting line between the centers of two discs. Otherwise, when the left discs enter, it will have a magnetic drag force problem. The magnets of the left discs are arranged at an interval rotating angle, the magnets of the right discs are also arranged at an interval rotating angle, and the magnets of the mid discs are also arranged at an interval rotating angle in such a manner that the four mid discs are arranged at an angle of 180/4=45 degrees. In this way, the rotating force is continuous.

The affecting time interval of the magnetic forces of four mid discs is shorter than that of two mid discs, the magnetic forces reaches their maximum value every 45-degree of rotation. Since the affecting time interval of the magnetic forces is shorter, the magnetic force action is more continuous, the acceleration effect will be better, and the power generating capacity will be increased. When the number of the mid discs is increased from 4 to 18, the mid discs will be subjected to a magnetic push and an attraction force (rotary force) every 180/18=10 degrees of rotation. Therefore, the more number of the mid discs, the more continuous of the magnetic force action, and the power generating capacity is greater.

To enable the magnets of the mid discs to be subjected to the maximum magnetic force of the magnets of the left and right discs, therefore, the NS direction of the magnets of the mid discs should be tangent to the circumference of the discs, while the NS direction of the magnets of the left and right discs should be directed towards the center of the discs.

Every 360-degree rotation of the four mid discs produces 8 times of magnetic-force acceleration (18 discs will have 36 times of acceleration). Since the magnets are of permanent type, they don't have the problem of soft and hard magnetic attraction forces. Besides, all the left, mid, right discs are made of non-magnetoconductivity material for prevention of the magnetic line's disturbance.

The two parallel permanent magnets of the respective mid discs must be opposite to each other in polarity direction so that when the magnets of the mid discs come in they will not be subjected to the drag force caused by the magnets of the left and right discs. The NS directions of two permanent magnets of the respective left and right discs must be coaxial, but their polarities must be opposite.

Based on our practical experiments, when the left (right) discs come in, there is no magnetic drag force exist, and they produce a very great magnetic force pushing the mid discs to rotate. Hence, the surplus magnetic force drives the generator to produce power.

If the diameter of the mid discs is approximately 60 mm, the push force caused will be insufficient when using 10×10×15 mm rod-shaped magnets, it should use the permanent magnets of 20×20×20 mm or bigger, so that the respective discs can produce a large enough magnetic force to maintain the rotation when rotating at their respective angles. The shape of the magnets is preferably square than rectangular.

The permanent magnets on the discs should be fixed in the grooves of the rotary discs, thus preventing the magnets from flying off the discs.

By installing a low-resistance wind power generator without iron core (AFPM generator made by Korea SEOYOUNG company, it can produce 24V 100 W power at 200 rpm, and 24 V 1030 W at 460 rpm) on the main shaft of the mid discs, electric power can easily be generated permanently.

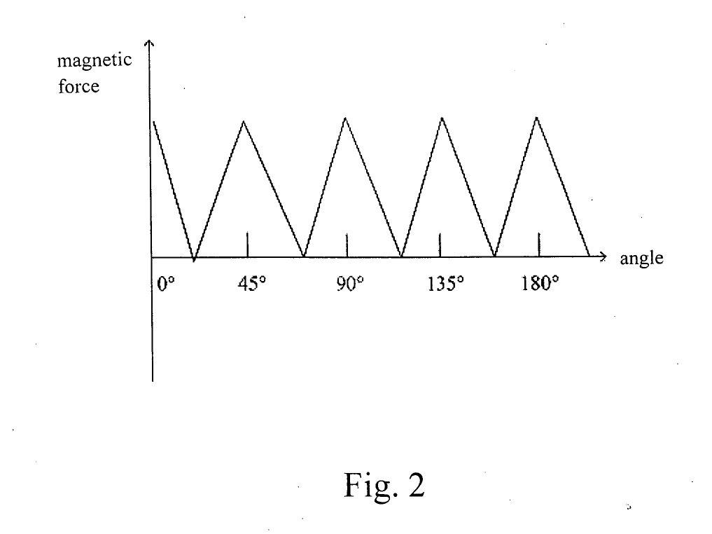

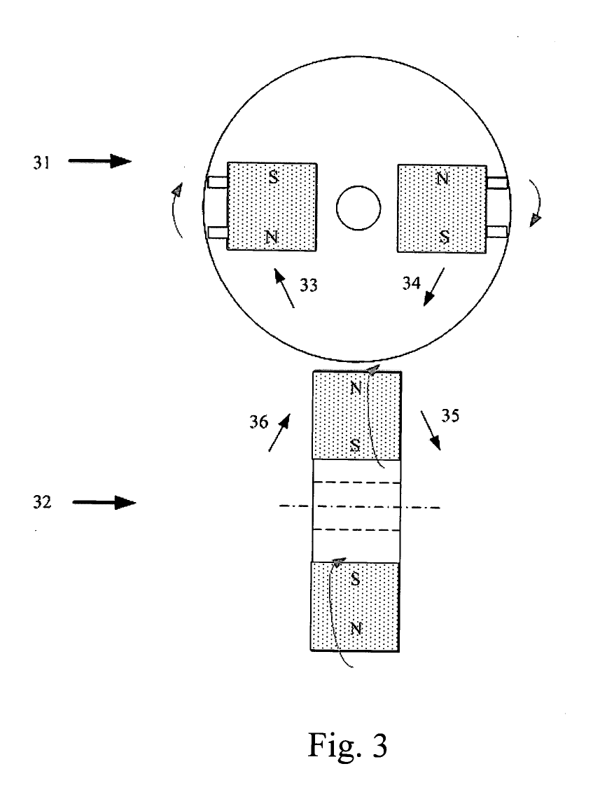

FIG. 2 shows that every 360-degree rotation of four mid discs produces 8 times of magnetic-force acceleration. FIG. 3 is a force analysis diagram of the rotary discs, the left (or right) disc 32 at the bottom of the drawing rotates vertically with respect to the paper surface, and the mid disc 31 at the top thereof rotates in a direction parallel to the paper surface.

It is clearly seen that one magnet on the mid disc 31 is pushed by a push force 33 to rotate upward, and the other magnet is attracted by an attraction force 34 to rotate downward, therefore the magnetic force will drive the mid disc 31 to accelerate.

Although the magnets on the left discs 32 (or right discs) are subjected to the counterforce 35, 36 to the push force 33 and the attraction force 34 of the mid discs 31, the counterforce 35 and 36 are parallel to the paper surface and will not affect the rotation of the left disc 32 (or right disc) in a direction vertical to the paper surface. Therefore, the left disc 32 (or right disc) will not be subjected to any magnetic drag forces during rotation.

The mid disc 31 will accelerate its rotation when it is subjected to the push force and the attraction force. In addition to be accelerated for rotating, the mid disc 31 can also provide a small part of its power to let the left disc 32 (or the right disc) rotate. Since the rotation speed of the left disc 32 (or the right disc) is much slower than the mid disc 31, the left disc 32 (or the right disc) and the mid disc 31 must be interconnected to each other by chain wheels so that they can rotate synchronously. The discs must be equal in diameter so that the position at which the magnets meet after each 360-degree rotation will be fixed.

There is a surplus force F after deducting the force F2 provided for rotating the lower disc (the left or right disc) from the rotary force F1 exerted on the mid disc 31 (surplus force F=F1−F2, and F1>>F2), and the surplus force F accumulates along with the increase in the number of revolutions. Therefore, the rotary disc type power equipment of the present invention can rotate continuously, becoming a perpetual motion machine.

The method of increasing the surplus force F is to reduce the diameter of discs, increase the size of the magnets, and reduce the distance between the discs.

The design of the transmission mechanism is shown in FIG. 4.

Since the friction loss of the chain wheel transmission mechanism is lower than that of the gear transmission mechanism, the present invention mainly uses the chain wheel, and the motion-transmitting direction of the chain 40 is not parallel to the ground.

A constant velocity universal joint 41 is used to turn the transmission direction of the main shaft of the discs 42 backward 90 degrees to rotate a main chain wheel 44, and then the main chain wheel 44 transmits power to the subsidiary chain wheels 45, 46, 47 and 48 behind the left and right discs (the resistance of the universal joint is lower than that of bevel gear).

The five chain wheels 44, 45, 46, 47 and 48 are arranged in the same plane and located behind the left and right discs 43.

The four horizontal mid discs 42 are coaxial and are connected to a generator 49, and the four left and right discs 43 are not arranged in the same axis.

If the chain and the chain wheels (or bevel gear) are made of magnetoconductive material, they should be arranged at a distance where they can't interfere with the rotation of the magnets.

While we have shown and described an embodiment in accordance with the present invention, it is clear to those skilled in the art that further embodiments may be made without departing from the scope of the present invention.

What is claimed is:

1. Coupled magnetic rotary discs for power generating, comprising at least four rotary discs, half are vertical rotary discs and half are horizontal rotary discs, the rotary discs being made of non-magnetoconductive material, two permanent magnets being fixed on each rotary disc; wherein each vertical rotary disc is corresponding to a nearby horizontal rotary disc, the horizontal discs rotate coaxially, and the vertical discs rotate about different axes; the rotary discs are interconnected by gears, chain wheels or constant velocity universal joints and thus rotate synchronously, so that a position at which the magnets meet after each 360-degree rotation of the respective rotary discs will be fixed, and the motion-transmitting direction of the chain is not parallel to the ground; the polarity direction of the permanent magnets on the respective rotary discs is properly arranged to prevent the generation of magnetic rotary drag force, the magnets on the horizontal rotary discs are subjected to a push force and an attraction force of the permanent magnets on the vertical discs; the respective vertical rotary discs are arranged at different rotary angular positions so that the horizontal discs will be subjected to a magnetic force at certain angle interval of rotation.

2. The coupled magnetic rotary discs for power generating as claimed in claim 1, wherein the NS direction of the magnets on the horizontal rotary discs is tangent to the circumference of the rotary discs, and the NS direction of the magnets on the vertical rotary discs is in the direction toward the center of the rotary discs.

3. The coupled magnetic rotary discs for power generating as claimed in claim 1, wherein the two permanent magnets on the respective horizontal magnets are parallel to each other and their polarity directions are opposite to each other; the NS directions of two permanent magnets of the respective vertical discs are coaxial, but their polarities are opposite.
